(19) United States
(12) Patent Application Publication
(10) Pub. No.: US 2006/0235724 A1
(43) Pub. Date: Oct. 19, 2006

(54) Method and system for providing low cost, readily accessible healthcare

(76) Inventor: Bert Rosenthal, Encino, CA (US)

Correspondence Address: FOLEY & LARDNER LLP, 150 EAST GILMAN STREET, P.O. BOX 1497, MADISON, WI, 53701-1497, US

(21) Appl. No.: 11/105,220

(22) Filed: Apr. 13, 2005

(51) Int. Cl. G06Q 50/00

(52) U.S. Cl. 705/2

(57) ABSTRACT

A method for providing low cost, readily accessible healthcare includes providing a healthcare clinic at which a medical service is provided to patients during a visit to the healthcare clinic, receiving patient information from the patient where the patient information does not include insurance information, providing the medical service to the patient, and requiring, during the visit to the healthcare clinic, the patient to pay an inclusive service fee in return for the medical service, where the service fee is the same regardless of the medical service provided.

### FIELD OF THE INVENTION

The present invention relates generally to the field of healthcare and, more specifically, to a method and system for providing low cost, readily accessible medical services.

### BACKGROUND OF THE INVENTION

The healthcare crisis in the United States has reached unprecedented levels and threatens to deteriorate even further in the future. There are currently over forty million Americans without health insurance and the number is growing. Further, a large portion of the population is under-insured and does not access the healthcare system because they cannot afford the cost of their deductibles and co-insurance payments. Exacerbating this problem is the rising cost of medical care and medical insurance. The national rate of healthcare premium inflation is over eleven percent per year.

In addition to being inaccessible to a large percentage of the population, the current healthcare system is also extremely inefficient. Healthcare providers spend large sums of money recording and filing their patient's insurance information and then dealing with the insurance companies to verify patient coverage and receive reimbursement for medical services provided. Large amounts of resources are also spent filling out paperwork, keeping patient records, and dealing with non-insurance related billing issues.

There are also inefficiencies in the methods used by medical service providers to diagnose and treat patients. In general, the medical profession does not utilize a best practices approach such that there is no readily accessible, accumulated knowledge base which allows medical service providers to obtain the latest and most efficient methods for diagnosis and treatment of various illnesses. This lack of best practices requires medical service providers to invest more time in testing before a diagnosis is made and more time in consultation and research before an optimal treatment is prescribed.

Drug prescription procedures are also flawed under the current healthcare system. Instead of being based on optimal treatment considerations, prescribing habits are based on biased pharmaceutical marketing strategies and flawed drug studies. Pharmaceutical companies market high-priced, brand name drugs to the exclusion of generic equivalents. In addition, some such companies provide financial incentives for healthcare providers to prescribe their higher priced drugs. Also, drug studies are often sponsored by pharmaceutical companies, resulting in only favorable results being presented to pharmacists and medical service providers. The end result of the incentive programs and data manipulation is higher priced prescription drugs for patients. The public would be best served if comparison drug trials would be undertaken between comparable dosage regimens of generic and branded drugs with conclusions that include both clinical outcomes and cost/value analyses.

This medical care crisis extends to both primary and non-primary healthcare services, but is much more of an issue in the context of commonplace primary care and urgent care services. The latter generally consists of the diagnostic and therapeutic response to recent onset symptoms such as headache, skin eruptions, chest pain, cough, earache, fever, abdominal pain, etc. In general, primary care refers to preventative healthcare and routine medical care that is typically provided by a doctor trained in internal medicine, obstetrics, pediatrics, or family practice. Primary care may also be provided by nurses, nurse practitioners and physician's assistants. Primary care services include, but are not limited to, diagnosis of common illnesses, treatment of common illnesses with or without prescription drugs, and instruction regarding preventative measures. Non-primary healthcare generally refers to emergency services and services provided by specialists to whom patients are referred by a primary care provider.

While problems in the healthcare system affect virtually all of the population in one form or another, the inaccessibility and inefficiency of healthcare are especially problematic for the working poor. A large percentage of the working poor reside in metropolitan areas and are concentrated in ghettos and barrios. These individuals often have little or no access to credit or insurance and hence live in a cash economy. Some people contend that mainstream healthcare ignores this population and its plight because of its geographical location, its inability to pay the going rate, and its existence at the bottom of the socioeconomic ladder.

Thus, there is a need for efficient, low cost healthcare that is accessible to any member of the population, regardless of insurance, credit, or social status. Further, there is a need for efficient healthcare that is available to individuals living in a cash economy. Further yet, there is a need for a healthcare provider that does not involve insurance companies or other third party billing entities. Further yet, there is a need for efficient healthcare in which medical service providers utilize a best practices method of diagnosis and treatment. Further yet, there is a need for efficient healthcare that provides patients with generic prescription drugs at no or little additional cost. Further yet, there is a need for efficient healthcare which provides the great majority of routine laboratory testing at no additional cost. Further yet, there is a need for healthcare delivery which provides for steep discounts for cash for purchased services such as complex laboratory tests and imaging of various sorts.

### SUMMARY OF THE INVENTION

An exemplary embodiment relates to a method for providing low cost, readily accessible healthcare. This method includes providing a healthcare clinic at which a medical service is provided to patients during a visit to the healthcare clinic, receiving patient information from the patient where the patient information does not include insurance information, providing the medical service to the patient, and requiring, during the visit to the healthcare clinic, the patient to pay an inclusive service fee in return for the medical service, where the service fee is the same regardless of the medical service provided.

Yet another exemplary embodiment relates to a system for providing low cost, readily accessible healthcare. This system includes a healthcare clinic, a patient information database, and a payment apparatus. The healthcare clinic provides medical services to patients regardless of whether the patient has insurance. The patient information database stores patient information for purposes of recording and identification. The payment apparatus accepts a fee from the patient in payment for a medical service and issues a receipt to the patient upon a patient's request wherein the fee is a flat fee regardless of the medical service provided.

Another exemplary embodiment relates to a method for providing low cost, readily accessible healthcare. This method includes obtaining patient information relating to a patient where the patient information does not include health insurance information, receiving payment for a medical service performed for the patient after registration to receive the medical service, and providing the medical service where the medical service comprises one or more of a plurality of primary care services and wherein the payment for the medical service is the same regardless of the medical service provided.

Another exemplary embodiment relates to a system of providing low cost, readily accessible healthcare. This system includes a database including patient information relating to a patient where the patient information does not include health insurance information and a payment apparatus that accepts payment in cash and using a card with a magnetic strip or bar code containing identification information. The payment apparatus is located in a healthcare facility and is configured to receive payment for a medical service performed for the patient after registration to receive the medical service. The medical service includes one or more of a plurality of primary care services and the payment for the medical service is the same regardless of the medical service provided.

### BRIEF DESCRIPTION OF THE DRAWINGS

FIG. 1 is an overview diagram of an exemplary embodiment implementing low cost, readily accessible healthcare.

FIG. 2 is a block diagram illustrating an exemplary embodiment of low cost, readily accessible healthcare from the patient's perspective.

FIG. 3 is a form requesting minimal patient information upon arrival at a healthcare clinic in accordance with an exemplary embodiment.

FIG. 4 is an acknowledgement and waiver agreement form to be signed by prospective patients in accordance with an exemplary embodiment.

FIG. 5 is a floor plan for a healthcare clinic in accordance with an exemplary embodiment.

FIG. 6 is a general map illustrating placement of a healthcare clinic in accordance with an exemplary embodiment.

FIG. 7 is a general diagram illustrating a best practices approach utilized by medical service providers working at healthcare clinics in accordance with an exemplary embodiment.

FIG. 8 is a general diagram illustrating an efficient, cost effective management arrangement for healthcare clinics in accordance with an exemplary embodiment.

### DETAILED DESCRIPTION OF EXEMPLARY EMBODIMENTS

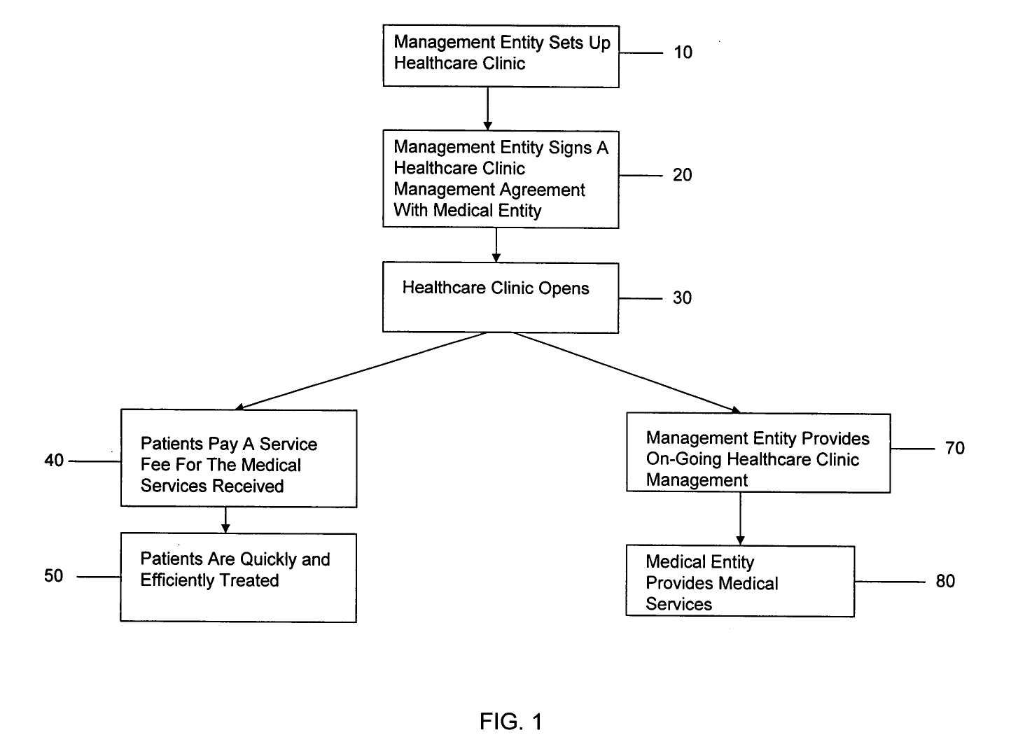

FIG. 1 illustrates operations performed to implement a low cost, readily accessible healthcare program. Additional, fewer, or different operations may be performed depending on the implementation. In one embodiment, the healthcare program can be implemented by providing medical services to patients at a healthcare clinic. In another embodiment, to improve efficiency and lower costs, the healthcare clinic can be run by cooperation between a management entity and a medical entity.

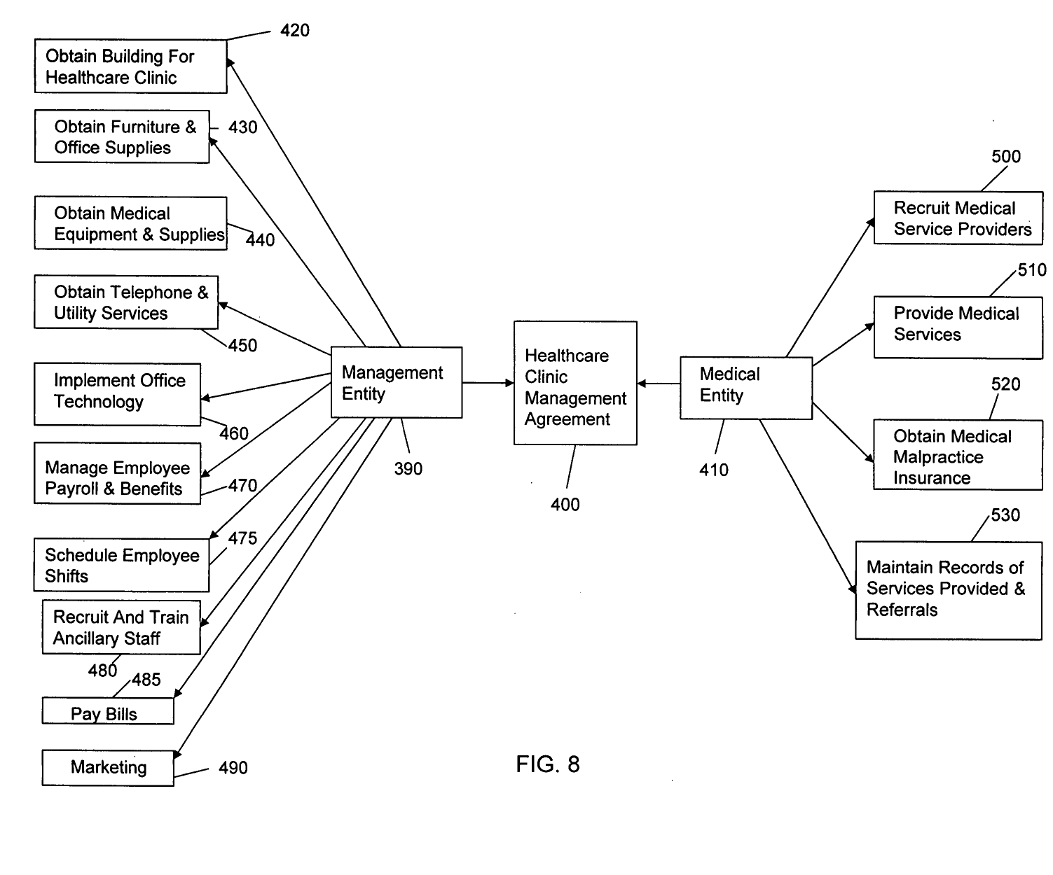

In an operation 10, a management entity sets up a healthcare clinic by selecting an appropriate location and building, leasing, or purchasing a building in which to place the healthcare clinic. Set up can also include obtaining furniture, medical equipment and medical supplies, contracting for utilities, implementing an office technology plan, recruiting and training ancillary staff, and anything else necessary to get the healthcare clinic up and running. In an operation 20, the management entity and a medical entity can sign a healthcare clinic management agreement which specifies the duties of each party. The primary duties of the management entity can include the initial healthcare clinic setup and on-going healthcare clinic management. The primary duty of the medical entity can be to provide professional medical services. These duties are described further with reference to FIG. 8. This cooperatively-run healthcare clinic minimizes costs and maximizes efficiency by not requiring the management and medical entities to perform duties beyond their respective expertise. However, in an alternative embodiment, the healthcare clinic can be independent, run solely by a medical entity, run solely by a management entity, or run by any other entity or combination of entities.

Once the initial healthcare clinic setup is complete, the healthcare clinic can open its doors and begin to offer medical services in an operation 30. In an operation 40, the patient pays a service fee for the medical services received. In a preferred embodiment, the patient is required to complete payment of the service fee before the patient leaves the healthcare clinic such that the administrative costs of payment plan billing and third party billing are eliminated. Further, immediate billing allows patients to obtain medical services regardless of credit or insurance coverage.

In areas where there is a high volume of patients, the service fee can be kept low such that virtually any member of the population can afford it. In one embodiment, the service fee is kept less than two day's minimum wage salary. In an alternative embodiment, the service fee is approximately fifty dollars per visit. In another embodiment, the service fee paid in operation 40 is receivable as cash only. Alternatively, the healthcare clinic may accept other forms of payment, including, but not limited to, personal checks, debit cards, and credit cards. Payment can also include vouchers from any payor by pre-arranged contract, including government programs.

In one embodiment, payment is implemented via money in a patient account. A patient account allows individuals to set aside small sums of money which can subsequently be used to pay the service fee at the healthcare clinic. This method of payment can be beneficial to individuals who prefer to plan ahead but do not always have cash on hand. The patient account is funded by the patient and maintained by the healthcare clinic, the management entity, a bank, or other appropriate entity. Patient account funding can be implemented through patient payroll deductions and/or random payments by the patient. In any event, the funds in the patient account are immediately accessible to the healthcare clinic. Depending on the implementation and applicable laws, the patient account may or may not be interest bearing. Further, the patient account cannot be used by the patient to delay payment. If the patient account does not contain enough funds to pay the service fee for the visit, the patient is required to pay the difference during the visit to the healthcare clinic.

In another embodiment, payment can be implemented via a self-service kiosk. During an initial visit to the healthcare clinic, patients can be asked to provide personal information to a receptionist for the purposes of identification and records keeping. The receptionist can then provide the patient with a healthcare clinic patient identification card, patient identification number, or other method of identification that allows a self-service kiosk to identify the patient. On subsequent visits, patients can use the patient identification to access the self-service kiosk, which in turn can be used to implement payment of the service fee, completion of a waiver and acknowledgement agreement, changes in the patient's personal information, and/or issuance of correct change and a receipt. In an alternative embodiment, the patient identification can be the patient's social security number, the patient's full name, a password, etc. Use of a self-service kiosk can reduce administrative costs by simplifying patient billing and reducing the need for a receptionist. In one embodiment, payment of the service fee at the self-service kiosk can only be done using cash. In an alternative embodiment, payment of the service fee at the self-service kiosk can be done using cash, credit card, debit card, and/or by accessing a patient account.

In an operation 50, patients are quickly and efficiently treated by a staff of trained medical service providers. Quick treatment can be implemented utilizing an optimal healthcare clinic layout, requiring only minimal information from patients before they are seen by a medical service provider, and having bilingual staff in areas with large non-English speaking populations. For instance, if the healthcare clinic is located in a Hispanic barrio, staff can be required to speak both English and Spanish. Efficient treatment can be implemented utilizing a best practices diagnosis and treatment approach, having a laboratory inside of the healthcare clinic, dispensing low or no cost prescription drugs from a pharmacy within the healthcare clinic, and implementing an electronic filing and records system.

In an operation 70, on-going healthcare clinic management is provided by the management entity. On-going management can include, but is not limited to, managing payroll and employee benefits, keeping medical and other supplies stocked, paying the healthcare clinic's bills, marketing, and scheduling shifts. In an operation 80, the medical entity provides medical services after recruiting medical service providers. The medical entity may also be required to obtain medical malpractice insurance for the medical service providers and keep records of medical services provided to each patient. Duties of the management and medical entities are described in more detail with reference to FIG. 8.

The healthcare clinic described with reference to FIG. 1 provides a low cost option for obtaining quick, efficient medical services for individuals with limited access to the current healthcare system. In a preferred embodiment, the medical services provided by the healthcare clinic are primary care services and are performed by primary care providers. However, the method and system for providing low cost, readily accessible healthcare can be extended to other forms of healthcare, including, but not limited to emergency services, dental services, optometric services, psychiatric services, counseling services, other specialized services, etc.

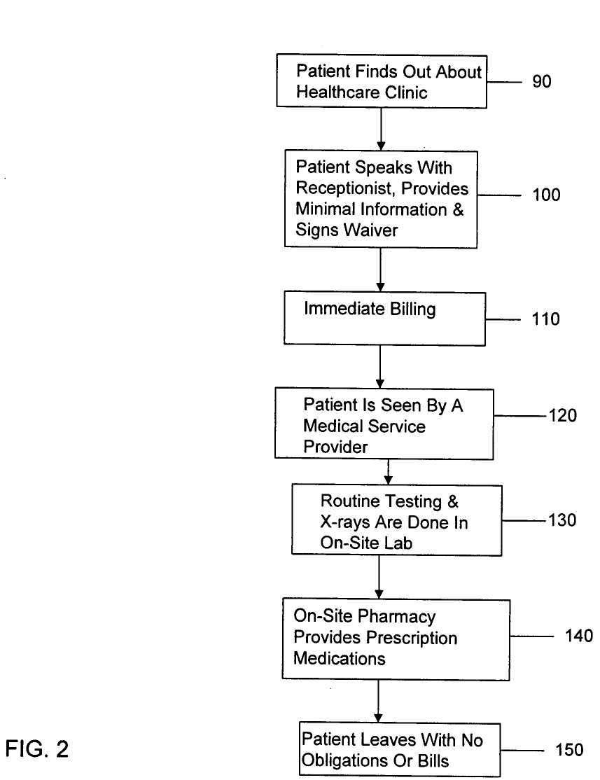

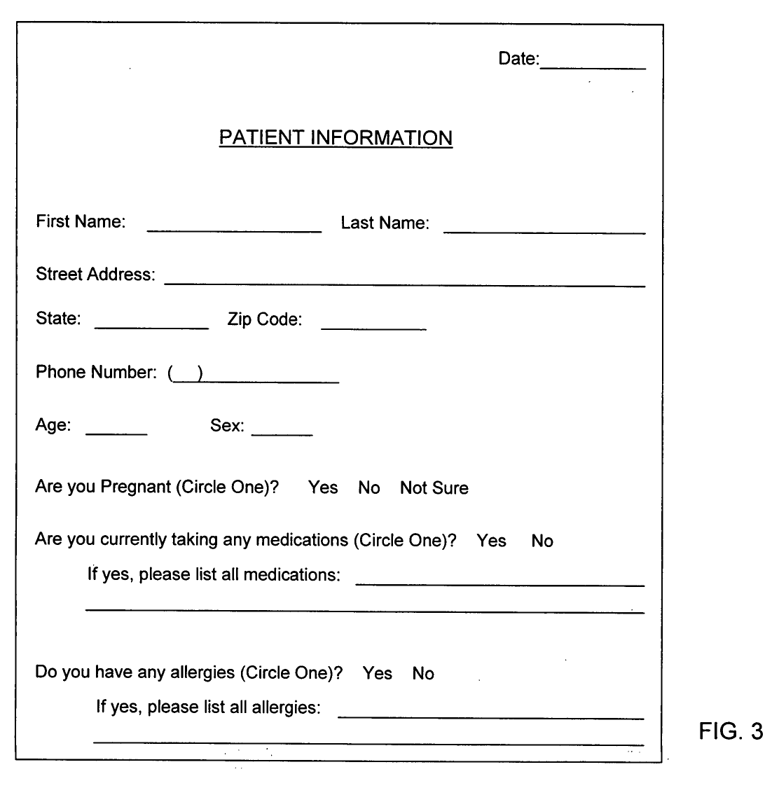

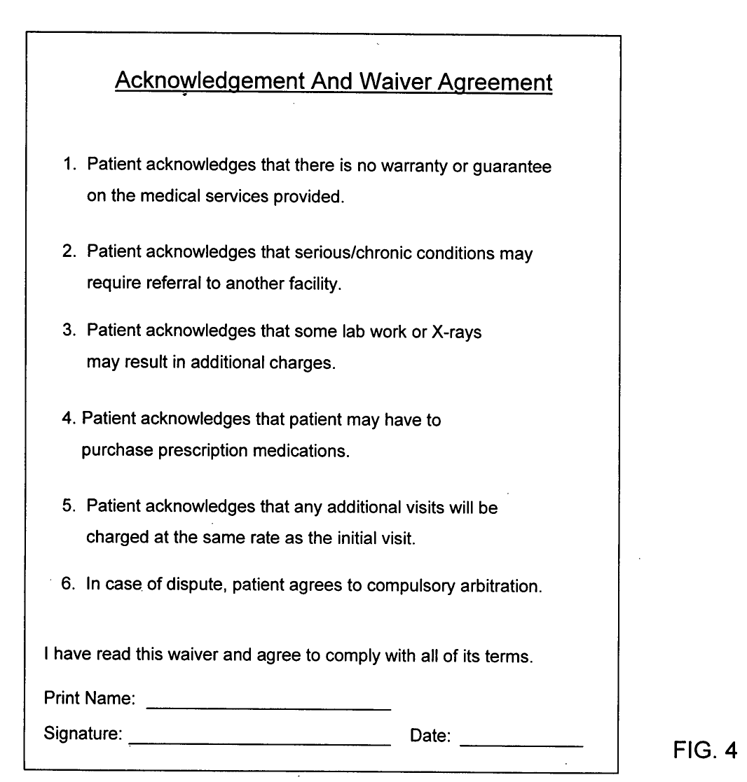

FIG. 2 illustrates exemplary operations performed in the implementation of the healthcare program described with reference to FIG. 1, from the patient's perspective. In an operation 90, prospective patients find out about the healthcare clinics by word of mouth or as a result of successful marketing by the management entity, the medical entity, or the healthcare clinic. In an operation 100, upon arrival at the healthcare clinic, patients can speak with a receptionist, provide minimal personal information, and/or sign an acknowledgement and waiver agreement form. Exemplary embodiments of the minimal personal information required and an acknowledgement and waiver agreement form are described with reference to FIG. 3 and FIG. 4, respectively. To ensure efficiency in the check-in process, the management entity can ensure that the medical service providers and the ancillary staff, including the receptionist, are fluent in the languages predominantly spoken near the location of the healthcare clinic.

In an alternative embodiment, instead of providing patient information to a receptionist, patient information from a prior visit may already be stored in an electronic patient information database. Further, patients may have identification such as a healthcare clinic patient identification card or patient identification number that was previously provided to the patient by the healthcare clinic. In such cases, patients can check in rapidly via a self-service kiosk, a computer station, or by presenting the identification to the receptionist. In one embodiment, patients can bypass the receptionist altogether and utilize the self-service kiosk or computer station to provide patient information, check in, and/or receive a patient identification during their first visit to the healthcare clinic.

In an operation 110, healthcare clinics bill patients immediately. This method of billing saves time and money for both the healthcare clinic and the patient. Since insurance information is not required and may not even be accepted, there is no need for the healthcare clinic to spend valuable time filing and recording the patient's insurance information or contacting and negotiating with insurance companies or other third party billing entities. Not requiring insurance information also allows individuals who have limited access to the current healthcare system to obtain high quality medical services for a reasonable fee. Further, immediate billing provides patients with peace of mind such that after patients leave the healthcare clinic they know that there are no obligations or bills coming in the mail.

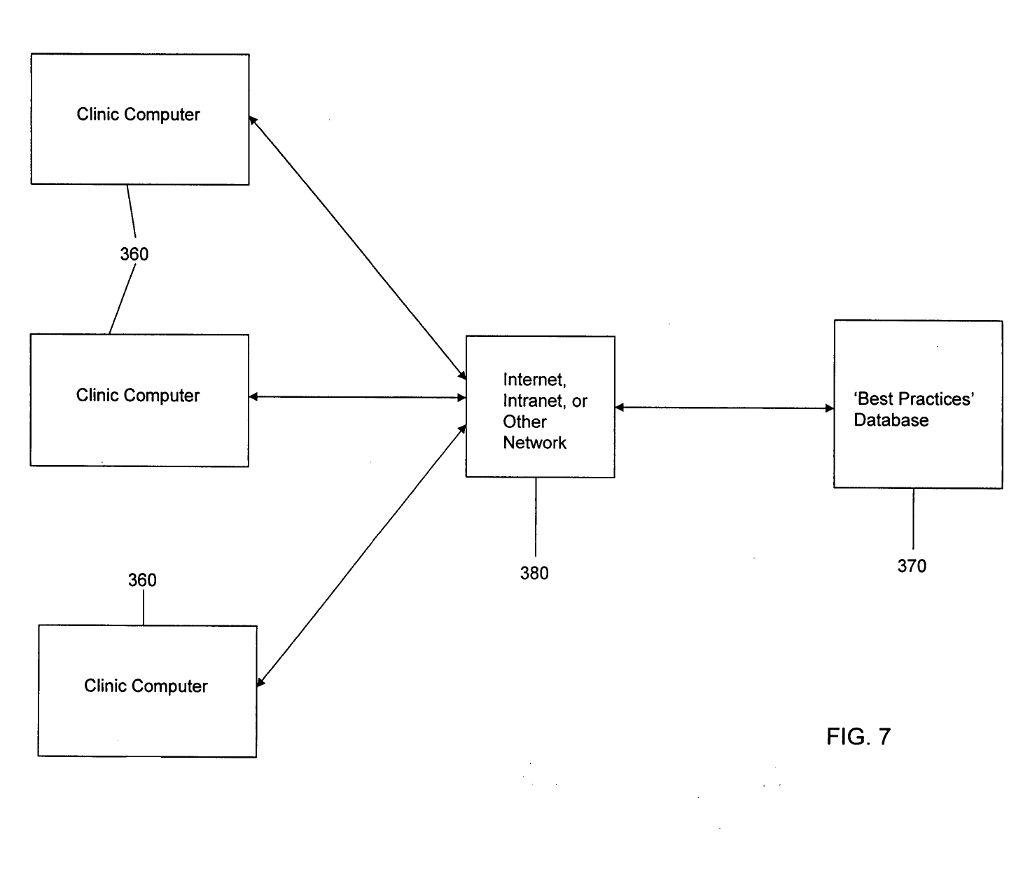

After checking in, patients are seen by a medical service provider in an operation 120. As described with reference to FIG. 7, in one embodiment, the medical service providers utilize a best practices approach to implement diagnosis and treatment. The best practices approach ensures that medical service providers are equipped with knowledge of trends in illnesses, geographical trends in diagnosis and treatment, common symptoms, and best methods of treatment based on the symptoms. Implementation of the best practices approach can be via an electronic best practices database of information that is constantly being updated and added to by medical service providers across a network. In one embodiment, medical service providers are able to successfully diagnose and treat each patient in twelve minutes or less.

Diagnosis may require X-rays and/or laboratory testing of a patient's blood, saliva, tissue, urine, etc. In an operation 130, routine laboratory testing is implemented by a technician in a laboratory located within the healthcare clinic. Routine X-ray procedures can also be implemented in the laboratory. Having an on-site laboratory reduces the need for costly outsourcing and also allows diagnosis to be made quickly and efficiently. On-site laboratory and X-ray work can be provided to patients at little or no additional cost to the service fee. In one embodiment, the cost of on-site laboratory and X-ray work is limited to twenty percent of the initial service fee. Conversely, if outsourced lab work is required, patients may be charged a significant additional fee and diagnostic results will take longer.

In addition to the best practices approach for treating illnesses, treatment can also be improved by placing a pharmacy within the healthcare clinic and providing patients with prescription medications at little or no additional cost in an operation 140. In an exemplary embodiment, the management entity or healthcare clinic objectively stocks the pharmacy such that physician's incentives, misleading pharmaceutical studies, and misaligned goals are no longer an issue. The primary goal of the in-house pharmacy is to obtain and provide low cost, high quality prescription medications. Thus, there is no incentive to use brand name drugs when equivalent generic drugs can be obtained and provided for patients at little or no additional cost to the initial service fee. In one embodiment, the cost of prescription medication from the on-site pharmacy is limited to twenty percent of the initial service fee.

After diagnosis and treatment, patients leave the healthcare clinic with no obligations or bills in an operation 150. Unlike traditional healthcare providers, which send bills including a variety of fees which may nor may not be payable by the patient's health insurance provider, the low cost, readily accessible healthcare system provides patients with peace of mind in that they know the bill is already paid. An additional benefit of immediate billing is that patients need not worry about having poor or no credit. Patients living in a cash economy are able to pay a minimal service fee for their medical services. In one embodiment of the healthcare system, patients are required to pay cash.

FIG. 3 illustrates an exemplary patient information form asking the patient to provide minimal information upon arrival at the healthcare clinic described with reference to FIGS. 1 and 2. Such information includes routine demographics and medical history information. The information requested and questions asked in the form of FIG. 3 serve the purposes of facilitating electronic patient records and informing primary care providers of treatment options. For instance, if a patient is pregnant or taking certain medications, various treatment options may not be feasible. In another embodiment, the only information requested of the patient may be his/her name or social security number to facilitate electronic patient information records. In yet another embodiment, address, phone number, age, and sex information may be optional. In yet another embodiment, any and all questions may be asked by the receptionist or medical service provider.

Patient information can be received via a receptionist and a paper form as illustrated in FIG. 3. Alternatively, patient information can be stored in a patient information database and need not be provided after the patient's first visit. In one embodiment, the healthcare clinic can obtain patient information by having the patient or patient's guardian enter it at a computer station or a self-service kiosk. In another embodiment, after providing the patient information, either manually or electronically, the patient is issued a healthcare clinic patient identification card or patient identification number such that on subsequent visits, the patient identification can be used to instantly access the patient's information, making check-in more efficient for both the patient and the healthcare clinic.

FIG. 4 illustrates an exemplary acknowledgement and waiver agreement form to be signed by prospective patients at the healthcare clinic described with reference to FIGS. 1-3. The form can be used to protect the healthcare clinic and ensure that patients understand the extent of the services that the clinic is capable of providing. In an alternative embodiment, the acknowledgement and waiver agreement form may be the only document presented to patients during check in and the patient's name may be used to facilitate an electronic record for the patient. The form of FIG. 4 is merely exemplary such that additional, fewer, and/or different terms may be used in practice.

Patients may be required to acknowledge that there is no warranty or guarantee on the services provided by the healthcare clinic. Such a term can be used to ensure that the patient understands that diagnosis will not always be possible and that treatment will not always be successful. With the level of uncertainty in the medical field, it is important for patients to acknowledge that perfection is not always attainable.

The primary goal of the healthcare clinics described herein is to provide low cost medical services that are readily accessible to any member of the population. In accordance with this goal, healthcare clinics may not be able to engage in complex, high cost laboratory testing, costly treatment of certain diseases, costly emergency services, various specialized services, etc. Thus, patients may also be required to acknowledge that very serious, rare, and/or chronic conditions may require referral to another facility and that certain lab work or X-rays which require outsourced services may result in significant additional charges. In an exemplary embodiment, all outsourced services are either done at public facilities at no charge to the patient, or by contracted purchased services providers who deeply discount for cash. The cost of such services is disclosed to each patient at the time of referral.

Further, even though the healthcare clinics may include an on-site pharmacy, the pharmacy may not have access to all prescription medications. To keep costs down for all patients, certain prohibitively expensive drugs may not be available at the on-site pharmacy. Thus, it is important for patients to acknowledge that medication may need to be purchased at market prices from an outside pharmacy in certain cases.

Patients can also be asked to acknowledge that additional visits will be charged at the same rate as the initial visit. This is to ensure that patients realize that the healthcare clinic is not offering a service plan for a one-time fee and that there are no discounts for future visits. While there can be exceptions made on a patient-by-patient basis, it is important for patients to understand that in general, each visit will result in the patient paying the service fee.

Patients can also be asked to waive their right to the court system in case of dispute. A compulsory arbitration agreement can be beneficial to both the healthcare clinic and the patient. Arbitration is generally less time consuming than going through the court system, it allows the parties to have some say in who will hear their case, and it is private. After reading all of the terms on the acknowledgement and waiver agreement form, the patient is asked to print his/her name and sign and date the agreement if he/she agrees to comply with all the terms. As with the patient information form described with reference to FIG. 3, the acknowledgement and waiver agreement form can be made available in multiple languages to accommodate non-English speaking portions of the population.

In one embodiment, the acknowledgement and waiver agreement described with reference to FIG. 4 can be a paper form provided by a receptionist and filled out by the patient or the patient's guardian. In another embodiment, the acknowledgement and waiver agreement can be filled out and signed by the patient or the patient's guardian at a computer station or self-service kiosk. Depending on local laws, patients may be required to read and sign the acknowledgement and waiver agreement during each visit to the healthcare clinic before any medical services are provided.

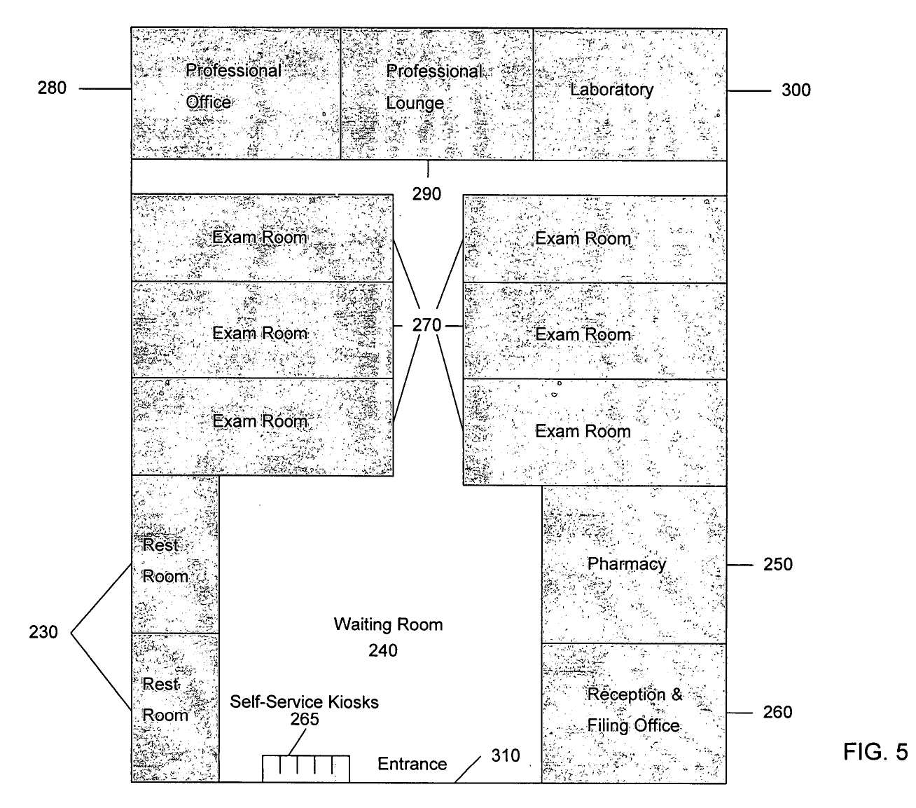

FIG. 5 illustrates an exemplary floor plan for the healthcare clinic described with reference to FIGS. 1-4. However, other floor plans may be used to achieve the same purpose. For instance, in cases where healthcare clinic buildings are leased and/or unalterable, the healthcare clinic may not be able to implement the floor plan of its choice. FIG. 5 illustrates a healthcare clinic including an entrance 310, two restrooms 230, a waiting room 240, a pharmacy 250, a reception and filing office 260, self-service kiosks 265, six exam rooms 270, a professional office 280, a professional lounge 290, and a laboratory 300. Room placement can increase efficiency of the healthcare clinic. Further, inclusion of a laboratory 300, pharmacy 250, and self-service kiosks 265 can help reduce costs and make healthcare clinics more convenient and patient-friendly.

Upon walking through the healthcare clinic entrance 310, patients can be immediately greeted and helped by a receptionist sitting in the reception and filing office 260. The receptionist can provide the prospective patient with the patient information form described with reference to FIG. 3 and/or the acknowledgement and waiver agreement form described with reference to FIG. 4, each in the appropriate language. The receptionist can also help prospective patients fill out and understand the forms, enter patient information in an electronic patient records system, and collect payment from the patient.

The self-service kiosks 265 supplement the reception and filing office 260 by allowing patients to provide their personal information, check themselves in, and/or read and sign the acknowledgement and waiver agreement, all without the need for a receptionist. The patient information can be used to automatically create an electronic patient record which is stored in a patient information database. Further, patients can pay the service fee at the self-service kiosks 265, receive correct change, and receive a receipt without having to involve a receptionist. Although the self-service kiosks 265 can reduce the need for a receptionist, in most cases a receptionist will still be needed to help illiterate patients and patients not comfortable using an automated system. Further, even if the healthcare clinic contains self-service kiosks 265, a receptionist may still be used to check patients in during their first visit to the healthcare clinic and issue them a form of patient identification. The patient identification, once issued, can be used by the patient to access the self-service kiosks 265 at the healthcare clinic. In one embodiment, patients can use the self-service kiosks 265 to check in during their first visit to the healthcare clinic and to receive a patient identification. In an alternative embodiment, the self-service kiosks 265 can be replaced by computer stations which offer all of the same functionality except the ability to receive payments and issue forms of patient identification.

Upon completion of the appropriate paperwork and payment of the service fee, patients can wait in the waiting room 240 until they are called by a medical service provider. In an alternative embodiment, patients can pay the service fee after they have been seen by the medical service provider but before they leave the healthcare clinic. When called upon, patients are taken into one of the six exam rooms 270 for examination by a medical service provider. After examining a patient, medical service providers can consult a best practices database in the professional office 280 to help make a diagnosis and determine optimal treatment options. In an alternative embodiment, each of the six exam rooms 270 can be equipped with access to the best practices database such that help with decisions can be obtained while the patient is being questioned and examined by the medical service provider. The professional office 280 can also be used for medical research, updating electronic patient records, and consulting with other medical service providers.

The on-site laboratory 300 of FIG. 5 eliminates much of the need for high-priced outsourcing of routine procedures. The laboratory 300 allows routine X-rays and medical testing to be done at a fraction of the outsourced cost. In addition, having the laboratory 300 on-site increases efficiency such that medical service providers do not need to spend time sending samples off-site and waiting for a response. This results in patients getting faster, less costly results.

Further increasing the cost effectiveness, efficiency, and convenience of the healthcare clinics is an on-site pharmacy 250. Utilization of an on-site pharmacy 250 can allow the healthcare clinic to provide many prescription medications at little or no additional cost to the patient because the on-site pharmacy 250 can be stocked and run by the healthcare clinic or the management entity. The medical service providers will be more likely to prescribe generic equivalents because they are available on-site. Patients benefit by receiving prescription medications at little or no additional cost and by not having to go to an outside entity to fill their prescriptions.

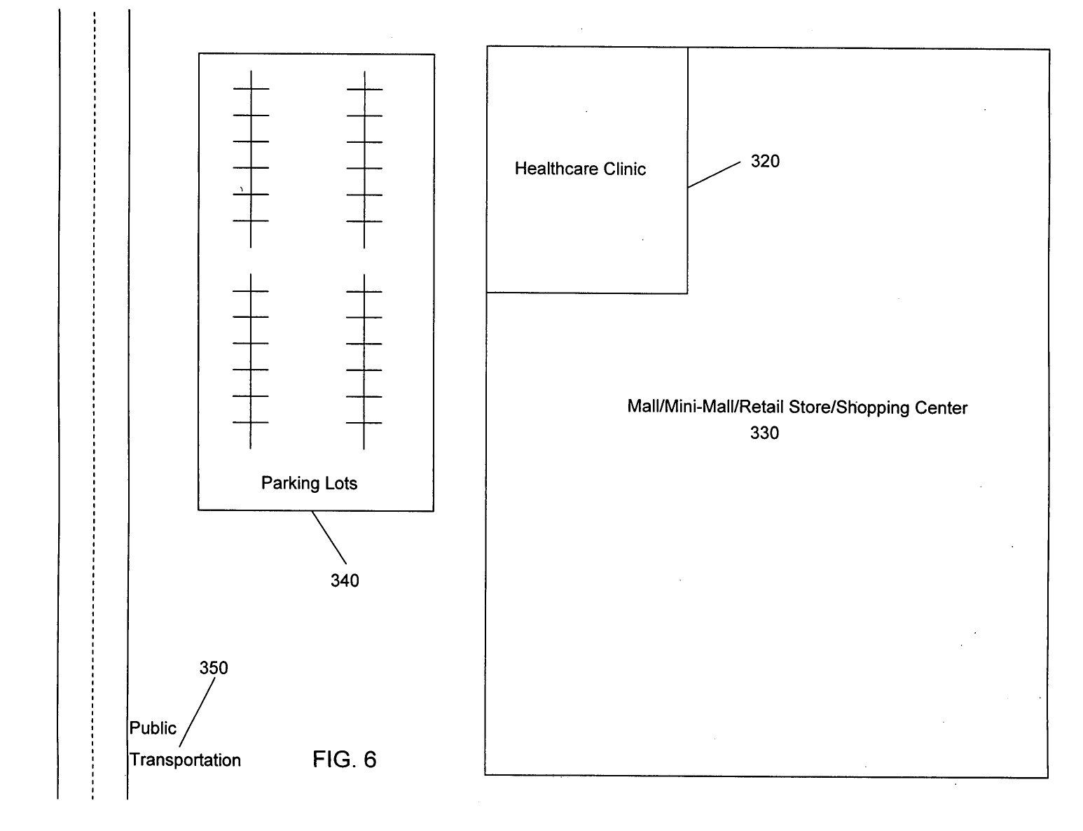

A major goal of the healthcare clinics described herein is accessibility for all members of the population. Thus, healthcare clinic location is an important factor. Important location-related factors include the availability of close, free parking and nearby public transportation. FIG. 6 illustrates an exemplary healthcare clinic placement. A healthcare clinic 320 can be placed in or adjacent to malls, mini-malls, retail stores, and/or shopping centers 330. Such shopping centers are generally accessible to the public, offer free parking 340, and are reachable via public transportation 350 such as buses, subways, trains, etc. Further, patients may be able to do some shopping during their trip to the healthcare clinic 320 and store proprietors can benefit from the additional customers brought in. While the healthcare clinic placement illustrated in FIG. 6 may be beneficial, other accessible locations may be equally suitable. For instance, a healthcare clinic in a separate building, on a bus route, and with an adjacent parking lot can fulfill the same purpose of accessibility. In an alternative embodiment, healthcare clinics may be placed in large stores which do not provide store employees with health insurance. With such a setup, both store customers and employees are able to take care of their health needs without making a separate trip to the healthcare clinic.

FIG. 7 illustrates an exemplary system for a best practices approach utilized by medical service providers working at the healthcare clinics described herein. Each healthcare clinic has one or more computers 360 on which medical service providers can input and request diagnosis and treatment information. These one or more computers 360 can be located in the professional office or the exam rooms described with reference to FIG. 5, or at some other central location. Information regarding diagnosis, best methods of treatment, illness trends, geographical trends, and other information which may make patient diagnosis and treatment more efficient can be stored in a best practices database 370. In one embodiment, medical service providers are required to manually update the best practices database 370 after treating each patient. In an alternative embodiment, the best practices database 370 is linked to a medical records database such that diagnosis and treatment information is automatically placed in the best practices database 370. The best practices database 370 may be accessible by the Internet, an intranet or some other network 380 such that medical service providers have access to the information and know-how of all other medical service providers employed by a healthcare clinic or chain of healthcare clinics.

In one embodiment, best practices guidelines are embedded in the electronic medical record database and appear in response to presenting symptom or symptom complex. The best practices guidelines are continuously modified on the basis of evolving medical service via the literature, and clinical experience based on clinical outcomes.

FIG. 8 illustrates an exemplary embodiment of an efficient, cost effective management arrangement for healthcare clinics. The specific advantages of a management entity providing all of the functionality in a healthcare provider setting except for the professional or clinical component is based on the resultant ability of the clinician within the professional corporation to be responsible only for clinical care and the management corporation to provide all of the ancillary service and financial support in a maximally efficient manner. A management entity 390 can enter into a healthcare clinic management agreement 400 with a medical entity 410, the agreement outlining the expectations and duties of each party. The primary duties of the management entity 390 can include healthcare clinic setup and continuing management. The primary duty of the medical entity 410 can be to provide professional medical services at the healthcare clinic. In one embodiment, both the management entity 390 and the medical entity 410 are corporations. In another embodiment, the management entity 390 and/or the medical entity 410 may be LLCs, partnerships, sole proprietorships, or any other legally recognized entities.

Setup may often start with the management entity 390 building, leasing, or purchasing a building for the healthcare clinic in an operation 420. As described with reference to FIG. 6, building location may be very important if the healthcare clinics are to be readily accessible. Once an appropriate building is obtained in operation 420, the management entity 390 can obtain telephone, Internet, and utility services from appropriate entities in an operation 450. Also, furniture and office supplies are obtained in an operation 430 and medical supplies and equipment are obtained in an operation 440 by the management entity 390 before the healthcare clinic can open. When possible, to reduce startup costs, the management entity 390 may purchase used medical equipment from websites such as www.medmatrix.com. In an operation 480, the management entity 390 can be required to recruit and train ancillary staff.

The management entity 390 can also agree to implement a healthcare clinic technology plan in an operation 460. The technology implemented can include computer stations for patient check-in, self-service kiosks for patient check-in and payment of the service fee, a patient information database for simple record keeping, a patient identification system to make check-in more efficient, and/or a best practices database as described with reference to FIG. 7. An electronic filing and patient records system can significantly reduce or eliminate the need to complete, file, and store paperwork, thus saving time and increasing efficiency. In one embodiment, the receptionist initiates an electronic patient record with personal information provided by the patient. In another embodiment, the electronic patient record can be created by the patient entering personal information at a computer station or self-service kiosk. Once created, medical service providers can easily add notation to the electronic record regarding symptoms, diagnosis, prescribed treatment, and referrals, without taking the time to fill out paperwork or enter the patient's personal information.

The management entity 390 can also agree to take care of general management issues including, but not limited to managing employee benefits and payroll in an operation 470, paying bills in an operation 485, and scheduling employee shifts in an operation 475. In an operation 490, marketing, another important facet for healthcare clinic success, can be implemented by the management entity 390. Promotional materials describing the low cost, readily accessible healthcare clinics can be distributed to churches, schools and individuals in local neighborhoods. The promotional materials may include flyers, brochures, billboards, pamphlets, etc. In addition, radio, newspaper, Internet and television advertising may be utilized by the management entity 390 to help promote the healthcare clinics.

The primary responsibility of the medical entity 410 is to recruit medical service providers in an operation 500 such that medical services can be provided in the healthcare clinics described herein in an operation 510. The medical entity 410 may also be required to obtain and show proof of medical malpractice insurance coverage for each of its medical service providers in an operation 520. Medical malpractice insurance premiums can be reimbursed by the management entity 390 pursuant to the healthcare clinic management agreement 400. The medical entity 410 may also be required to maintain accurate records of any diagnosis, treatment prescribed, and referrals made by medical service providers for each patient in an operation 530.

It should be understood that the above described embodiments are illustrative only, and that modifications thereof may occur to those skilled in the art. The invention is not limited to a particular embodiment, but extends to various modifications, combinations, and permutations that nevertheless fall within the scope and spirit of the appended claims.

What is claimed is:

1. A method for providing low cost, readily accessible healthcare, the method comprising:
providing a healthcare clinic, wherein the healthcare clinic is a location at which a medical service is provided to patients during a visit to the healthcare clinic;
receiving patient information from the patient, wherein the patient information does not include insurance information;
providing the medical service to the patient; and
requiring, during the visit to the healthcare clinic, the patient to pay an inclusive service fee in return for the medical service, wherein the service fee is the same regardless of the medical service provided.

2. The method of claim 1, further comprising utilizing a healthcare clinic management agreement between a management entity and a medical entity, wherein the management entity:
sets up the healthcare clinic, wherein setting up the healthcare clinic includes selecting and obtaining the location for the healthcare clinic, stocking the healthcare clinic with equipment and supplies, and recruiting an ancillary staff for the healthcare clinic; and
provides management services for the healthcare clinic, wherein the management services include implementing a records system for the healthcare clinic, implementing a payroll for the healthcare clinic, and paying bills of the healthcare clinic;
and the medical entity:
recruits one or more medical service providers;
obtains a medical malpractice insurance coverage plan for the one or more medical service providers; and
provides the medical service.

3. The method of claim 1, wherein the patient information is received from the patient from a patient information form filled out by any one of the patient and a patient's guardian.

4. The method of claim 1, wherein the patient information is received from an electronic patient record upon an identification of the patient.

5. The method of claim 4, wherein the identification of the patient is implemented by any one of a healthcare clinic patient identification card and a patient identification number.

6. The method of claim 1, wherein the medical service is a primary care medical service.

7. The method of claim 1, wherein the healthcare clinic includes an on-site pharmacy such that the patient is provided with a prescription medication at a cost which is no more than twenty percent of the service fee.

8. The method of claim 1, wherein the healthcare clinic includes an on-site laboratory such that routine lab work and X-rays are provided to the patient at a cost which is no more than twenty percent of the service fee.

9. The method of claim 1, further comprising utilizing an electronic patient records system at the healthcare clinic to minimize administrative costs and the service fee.

10. The method of claim 1, wherein the service fee is a cash fee greater than zero and less than two day's minimum wage salary.

11. The method of claim 1, wherein the service fee is payable by any one of a personal check, a credit card, and a debit card.

12. The method of claim 1, further comprising utilizing a best practices approach to diagnosis at the healthcare clinic, wherein the best practices approach to diagnosis utilizes an accumulated knowledge base of diagnostic techniques.

13. The method of claim 1, further comprising utilizing a best practices approach to treatment, wherein the best practices approach to treatment utilizes an accumulated knowledge base of treatment methods.

14. The method of claim 1, wherein the patient pays at least a portion of the service fee using a sum of money set aside in a patient account.

15. A system for providing low cost, readily accessible healthcare, the system comprising:
a healthcare clinic, wherein the healthcare clinic provides medical services to patients regardless of whether the patient has insurance;
a patient information database, wherein the patient information database stores patient information for purposes of recording and identification; and
a payment apparatus, wherein the payment apparatus accepts a fee from the patient in payment for a medical service and issues a receipt to the patient upon a patient's request wherein the fee is a flat fee regardless of the medical service provided.

16. The system of claim 15, further comprising a best practices database, wherein the best practices database includes an accumulated knowledge base to facilitate efficient diagnosis and treatment.

17. The system of claim 15, wherein the payment apparatus comprises a self-service kiosk.

18. The system of claim 17, wherein the self-service kiosk is activated by use of a healthcare clinic patient identification.

19. The system of claim 17, wherein the self-service kiosk accepts cash only and provides correct change.

20. The system of claim 17, wherein the self-service kiosk accepts any one of a credit card and a debit card.

21. The system of claim 15, further comprising a patient account database, wherein the patient account database keeps track of a sum of money set aside by the patient for medical services and allows the patient to use the sum of money to pay for at least a portion of a visit to the healthcare clinic.

22. The system of claim 21, wherein the sum of money comes from a payroll deduction of the patient.

23. A method for providing low cost, readily accessible healthcare, the method comprising:
obtaining patient information relating to a patient, wherein the patient information does not include health insurance information;
receiving payment for a medical service performed for the patient after registration to receive the medical service; and
providing the medical service, wherein the medical service comprises one or more of a plurality of primary care services and wherein the payment for the medical service is the same regardless of the medical service provided.

24. The method of claim 23, wherein the patient information is obtained from a form completed by the patient or a guardian of the patient.

25. The method of claim 23, wherein the patient information is obtained from clinic records after identifying the patient using a form of identification.

26. The method of claim 25, wherein the form of identification is a clinic-issued identification.

27. The method of claim 23, wherein the payment comprises a value greater than zero but less than a daily minimum wage.

28. The method of claim 23, wherein the payment is a cash payment.

29. The method of claim 23, further comprising determining a diagnosis of the patient utilizing an accumulated knowledge database.

30. The method of claim 23, further comprising assessing a treatment for the patient based at least in part on treatment data from a plurality of similar cases.

31. The method of claim 23, wherein payment is received and medical service is provided at a healthcare clinic having an on-site laboratory.

32. The method of claim 23, wherein the patent information is stored in an electronic medical records system.

33. The method of claim 23, wherein the payment is a voucher.

34. The method of claim 33, wherein the voucher is a government voucher.

35. A system of providing low cost, readily accessible healthcare, the system comprising:
a database including patient information relating to a patient, wherein the patient information does not include health insurance information; and
a payment apparatus that accepts payment in cash and using a card with a magnetic strip containing identification information, the payment apparatus being located in a healthcare facility and being configured to receive payment for a medical service performed for the patient after registration to receive the medical service, wherein the medical service comprises one or more of a plurality of primary care services and wherein the payment for the medical service is the same regardless of the medical service provided.

36. The system of claim 33, further comprising a best practices database comprising information relating to diagnosis and treatment for primary care services.

37. The system of claim 33, wherein the payment apparatus comprises a computer that accepts payments by entry of payment information upon registration at the healthcare facility.

38. The system of claim 33, wherein the payment apparatus comprises a self-service kiosk comprising a printing device that prints a receipt for the accepted payment.

39. The system of claim 33, wherein the patient information comprises an electronic medical history of the patient.
